(19) United States
(12) Patent Application Publication
(10) Pub. No.: US 2003/0209154 A1
(43) Pub. Date: Nov. 13, 2003

(54) Fluid path in a double layered cooking apparatus

(76) Inventor: Jong Peter Park, Diamond Bar, CA (US)

Correspondence Address: JONG PETER PARK, 1630 SUMMITRIDGE DR., DIAMOND BAR, CA, 91765, US

(21) Appl. No.: 10/207,753

(22) Filed: Jul. 30, 2002

(30) Foreign Application Priority Data
May 13, 2002 (KR) 10-2002-0026141

(51) Int. Cl. A47J 27/00

(52) U.S. Cl. 99/403; 126/390.1

(57) ABSTRACT

Disclosed is a double walled pan that includes an inner shell, an outer shell having a radius greater than that of the inner shell wherein ends of the outer and inner shells are sealed so as to provide a space between the outer and inner shells, a heat medium injected in the space, and a heat transfer plate bonded between the outer and inner shells, wherein a flow path of the heat medium is formed at the heat transfer plate or outer shell. The heat transfer plate is a disc, a concentric recess is formed between a center and an edge of the disc so as to have a predetermined width, and at least two straight grooves extend from the concentric recess to the edge. And, the heat transfer plate is flat, the flow path of the heat medium is formed at the outer shell, an outer heat transfer plate is installed at a lower part of the outer shell, and the outer heat transfer plate has at least one groove having the same shape of the outer shell.

### BACKGROUND OF THE INVENTION

1. Field of the Invention

The present invention relates to a double walled pan, and more particularly, to a double walled pan having a stacked bottom plates in which a fluid path is formed.

2. Background of the Related Art

A heating vessel used for cooking can be prepared to have a double body structure in order to distribute heat evenly on the food to be cooked.

A double walled pan according to a related art, as shown in FIG. 6, includes an inner shell 51 and an outer shell 53 of which the outer shell diameter is greater than that of the inner shell 51. Edges of the inner and outer shells, 51 and 53 respectively, are sealed so as to provide a space having a predetermined interval between the inner shell 51 and outer shells 53. And, a fluid 52 such as air or silicon oil is injected into the space. In the drawing, air occupies the remaining pocket of space that is not filled with the silicon oil.

The bottom of the pan has a stacked structure. Specifically, the first heat transfer plate 54 made of aluminum (Al) is attached closely thereto between the inner shell 51 and outer shells 53 made of stainless steel. And, the second heat transfer plate 55 made of aluminum is attached between a reinforcement plate 56 made of stainless steel and the outer shell 53.

Such a double structured bottom of the pan is substantially heated by a flame of a heat source such as a gas burner under the pan for cooking. In this case, the heat source mainly heats the contact portion of the pan strongly. Even if excellent heat transfer enables the heat to be distributed evenly on the bottom and side walls of the pan, the temperature of the portion contacted directly with the flame rises abruptly than that of the rest portion of the pan. Hence, it is hard to achieve a uniform heat distribution on the pan.

### SUMMARY OF THE INVENTION

Accordingly, the present invention is directed to a double walled pan that substantially obviates one or more problems due to limitations and disadvantages of the related art.

An object of the present invention is to provide a double walled pan of which stacked bottom structure is improved so as to achieve heat distribution more uniform than that of the related art.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a double walled pan according to the present invention includes an inner shell, an outer shell having a radius greater than that of the inner shell wherein ends of the outer and inner shells are sealed so as to provide a space between the outer and inner shells, a heat medium injected in the space, and a heat transfer plate bonded between the outer and inner shells, wherein a flow path of the heat medium is formed at the heat transfer plate or outer shell.

Preferably, a circular recess is formed at the center of the heat transfer plate and the plurality of grooves extends from the circular recess to edges of a circumference in all directions.

Preferably, the plurality of grooves extends in parallel with each other from portions of a circumferential edge to the corresponding portions of the circumferential edge, respectively.

Preferably, the plurality of grooves extends from portions of a circumferential edge to the corresponding portions of the circumferential edge so as to cross with each other.

More preferably, eight grooves extend radially from the circular recess on the heat transfer plate.

Preferably, the heat transfer plate is a disc, a concentric recess is formed between a center and an edge of the disc so as to have a predetermined width, and at least two straight grooves extend from the concentric recess to the edge.

More preferably, the concentric recess has the width amounting to about a half of a radius of the disc and eight straight grooves extend from the concentric recess to the edge.

Preferably, the plurality of pillars is formed at the heat transfer plate and density of the pillars at a central or circumferential portion of the heat transfer plate is greater than that of the rest pillars.

Preferably, a flat heat transfer plate is attached to the heat transfer plate additionally.

Preferably, the heat transfer plate is flat, the flow path of the heat medium is formed at the outer shell, an outer heat transfer plate is installed at a lower part of the outer shell, and the outer heat transfer plate has at least one groove having the same shape of the outer shell.

More preferably, a stainless steel is added between the heat transfer plate and outer shell.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a layout of a heat transfer plate of a double walled pan according to the present invention;

FIG. 2 illustrates a cross-sectional view bisected along a cutting line II-II in FIG. 1;

FIG. 3 illustrates a cross-sectional view bisected along a cutting line III-III in FIG. 1;

FIG. 4 illustrates an entire cross-sectional view of the double walled pan along a cutting line IV-IV in FIG. 1, in which the heat transfer plate in FIG. 1 is bonded to inner and outer shells so as to construct a stacked bottom plate of the double walled pan;

FIG. 5 illustrates a cross-sectional view of a double walled pan according to another embodiment of the present invention along a cutting line IV-IV in FIG. 1, in which the heat transfer plate in FIG. 1 is bonded between an outer shell and another heat transfer plate attached to a bottom of an inner shell so as to construct a stacked structure of bottom plates;

FIG. 6 illustrates a cross-sectional view of a double walled pan along a cutting line IV-IV in FIG. 1 according to a related art; and

FIG. 7 illustrates a cross-sectional view of a double walled pan according to a further embodiment of the present invention along a cutting line III-III in FIG. 1, in which the heat transfer plate in FIG. 1 is attached to a lower portion of an outer shell having a bent bottom so that a flat heat transfer plate is bonded to a bottom of an inner shell to construct a stacked bottom plate of the double walled pan having a heat medium path.

### DETAILED DESCRIPTION OF THE PREFERRED EMBODIMENTS

Reference will now be made in detail to the preferred embodiments of the present invention, examples of which are illustrated in the accompanying drawings.

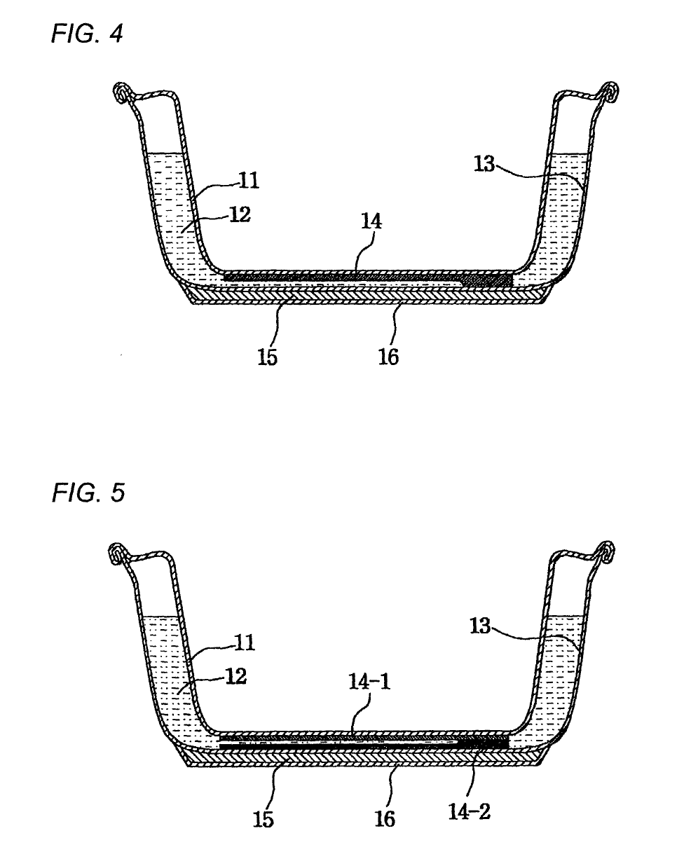

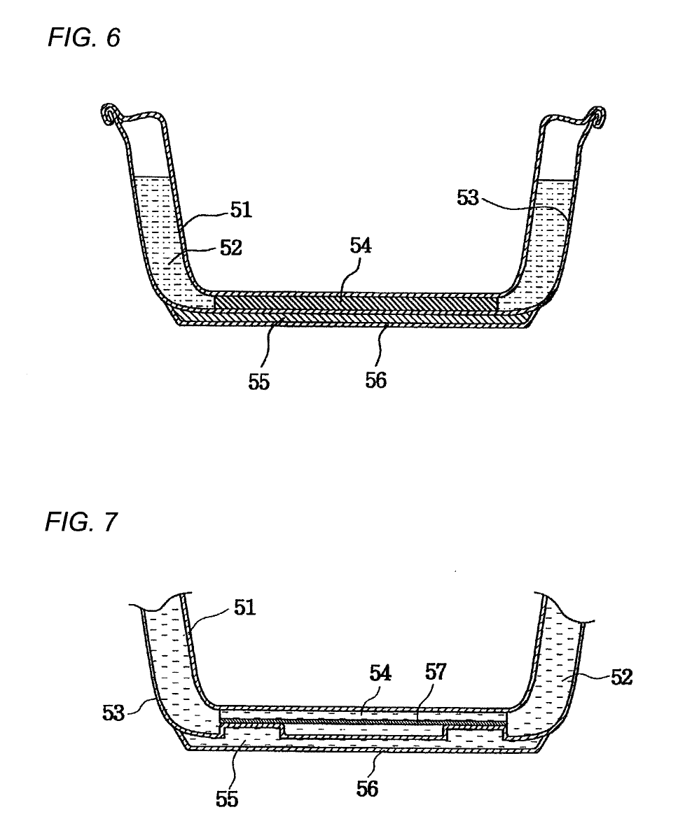

A double walled pan according to the present invention, as shown in FIG. 4, includes an inner shell 11 and an outer shell 13 of which diameter is greater than that of the inner shell 11. Edges of the inner shell 11 and outer shell 13 are sealed so as to provide a space having a predetermined interval between the inner shell 11 and outer shell 13. And, a fluid 12 such as air or silicon oil is injected into the space.

A stacked bottom structure of the pan according to the present invention includes a flow path for fluids such as air or silicon that serves as a heat medium between the inner and outer shell.

In an embodiment of the present invention shown in FIG. 4, stacked successively are a reinforcement plate 16 made of stainless steel, an outer heat transfer plate 15 made of Al, an outer shell 13 made of stainless steel, a heat transfer plate(inner heat transfer plate) 14 made of Al, and an inner shell 11. And, a flow path of a heat medium is formed in the heat transfer plate 14.

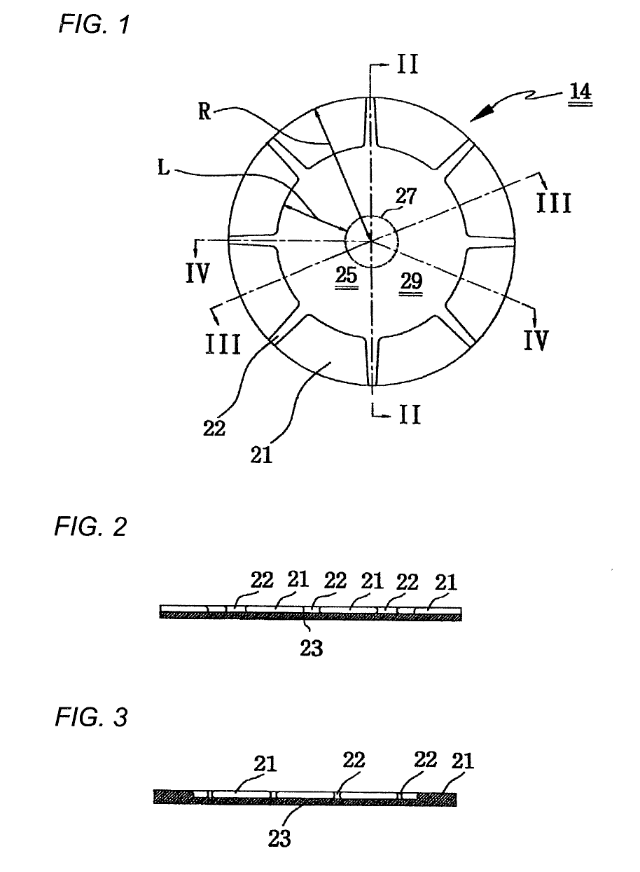

The heat transfer plate 14, as shown in FIG. 1, includes at least one groove 22 so as to form the flow path of the heat medium.

The groove 22 extends from a portion of an edge of the heat transfer plate to a confronting portion of the edge so as to enable the fluid to flow therein. Preferably, a circular recess 25 is formed at a central portion, a plurality of grooves 22 are formed from the circular recess 25 to a circumferential edge radially, and portions failing to have the grooves become protrusions or islands 21 so as to protrude higher than the grooves, respectively. In the drawing, there are eight islands 21 and eight straight grooves 22.

A plurality of grooves may extend in parallel from one portions of the circumferential edge to the other portions of the circumferential edge, respectively. Besides, a plurality of grooves may be formed so as to cross with each other.

Moreover, the heat transfer plate can be a disc, in which a circular island 27 indicated by a dotted line in FIG. 1 is formed at a center of the disc and a plurality of islands 21 are formed at a circumference. Hence, a concentric recess 29 having a predetermined width is formed between the circular island 27 at the center and a plurality of the islands 21 at the circumference. And, a plurality of straight grooves extends to the edge from the concentric recess 29.

More preferably, the concentric recess 29 is formed to have the width L about a half of a radius R of the disc, and eight straight grooves extend from the concentric recess 29 to the edge.

FIG. 4 illustrates an entire cross-sectional view of the double walled pan along a cutting line IV-IV in FIG. 1, in which the heat transfer plate having a flow path for the fluid heat medium is bonded to inner and outer shells so as to construct a stacked structure of bottom plates. Referring to FIG. 4, the fluid 12 such as air or silicon is injected in the airtight space (interval) of a lateral side of the pan, and it is clear that the fluid 12 can move in all directions along the grooves as a fluid pathway is formed on the heat transfer plate 14. A surface of the heat transfer plate failing to have the grooves is attached to the inner shell 11. On the contrary, the surface 23 as shown in FIG. 3 that does not have the grooves can be attached to the outer shell 13 as shown in FIG. 4.

The concentric recess 29 as shown in FIG. 1 is preferably formed at a portion over a lower bottom of the pan coming into contact directly with a gas flame when the pan is heated by a gas range. Such a portion varies in accordance with a size of the pan, a burner size of the gas range, a flame strength/amount, and the like. Generally, a small pan is heated by a small burner and a large pan is heated by a large burner. Accordingly, the width L of the concentric recess can be adjusted properly. If the width is excessively great, a mechanical strength may be weakened. In this case, at least two concentric recesses can be formed thereat.

Instead, sizes of the islands can be reduced so as to form a plurality of small pillar type islands. Density of the pillars formed on a unit area is adjusted in a manner that the density on the portion contacted directly with the flame of the burner is decreased while the density of the center and circumference is increased. Therefore, it is able to differentiate a heat transfer rate between the outer and inner shells without ruining the mechanical strength,

FIG. 5 illustrates a cross-sectional view of a double walled pan according to another embodiment of the present invention along a cutting line IV-IV in FIG. 1, in which a flat heat transfer plate 14-1 is attached to a lower part of an inner shell and another heat transfer plate 14-2 having a flow path of a heat medium fluid is attached between the flat heat transfer plate 14-1 and an outer shell so as to construct a stacked structure.

The embodiment in FIG. 5 is similar to that of the stacked structure in FIG. 4, but differs in that a stacked pan bottom structure includes an inner shell 11 made of stainless steel, a first heat transfer plate 14-1 made of Al so as to be attached to a lower portion of the inner shell 11, a second heat transfer plate 14-2 attached between the first heat transfer plate 14-1 and an outer shell 13, an outer shell 13 attached to the second heat transfer plate 14-2, an outer heat transfer plate 15 made of Al so as to be attached to the outer shell 13, and an reinforcement plate 16 made of stainless steel, which are stacked in order. At least one of the first and second heat transfer plates 14-1 and 14-2, as shown in FIG. 1, has at least one groove as a flow path of a heat medium. Such a groove has the same structure having been explained in the foregoing description.

FIG. 7 illustrates a cross-sectional view of a double walled pan according to a further embodiment of the present invention along a cutting line III-III in FIG. 1, in which the heat transfer plate having a flow path of a heat medium shown in FIG. 1 is attached to a lower portion of an outer shell having a bent bottom so that a flat heat transfer plate is bonded to a bottom of an inner shell to construct a stacked bottom plate of the double walled pan having a heat medium path.

The embodiment shown in FIG. 7 replaces the outer heat transfer plate 15 in FIG. 5 by a heat transfer plate 55 having a flow path of a heat medium, forms a bottom face of an outer shell so as to have the same shape of the groove formed on the heat transfer plate, and attaches a stainless steel plate 57 to a heat transfer plate 54 attached to a lower bottom face of an inner shell so as to reinforce a strength thereof.

In a stacked pan bottom structure of this embodiment, stacked in order are an inner shell 51 made of stainless steel, a first heat transfer plate 54 made of Al so as to be attached to a lower part of the inner shell 51, a stainless steel plate 57 attached to a lower part of the first heat transfer plate 54, an outer shell 53 having a groove as a flow path of a heat medium, a second heat transfer plate 55 having a flow path groove of the heat medium so as to be attached to a lower part of the outer shell 53, and a reinforcement plate 56 made of stainless steel so as to be attached to the second heat transfer plate 55.

Shapes of the grooves formed at the bottom of the outer shell 53 and the second heat transfer plate 55 are identical to each other, which can be various as mentioned in the above description.

The pan bottom of the stacked structure is heated locally by a heat source under the pan for actual cooking such as a flame generated from a gas burner. Yet, heat is transferred fast by the reinforcement plate 16 or 56, outer heat transfer plate 15 or 55, and outer shell 13 or 53, thereby enabling to achieve a uniform heat distribution. Besides, the heat of the outer shell 11 is transferred to the inner shell 11 directly through the islands or pillars or to the fluid 12. For the area contacted between the fluid and outer surface, if a total area of the islands or pillars of the heat transfer plate is sufficiently large when the outer and inner shells are contacted with each other directly, calorie transferred from the outer shell to the inner shell will increase. Even if the heat transferred from the outer shell to the fluid is transferred to a sidewall by heat transfer of the fluid itself, the flow of the fluid accelerates the heat transfer so as to make uniform heat distribution.

Accordingly, the double walled pan having the stacked bottom plate on which the fluid path is formed according to the present invention transfers the externally-supplied heat to the entire pan uniformly, thereby enabling to provide excellent heat distribution. And, the present invention slows down heating and cooling speeds by increasing heat capacity of the fluid, thereby enabling to provide the food cooked in the pan with good taste. Moreover, the present invention provides excellent heat preservation for keeping the food warm for a long term, thereby enabling to preserve the taste of the food excellently.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A double walled pan comprising: an inner shell; an outer shell having a radius greater than that of the inner shell wherein ends of the outer and inner shells are sealed so as to provide a space between the outer and inner shells; a heat medium injected into the space; and a heat transfer plate bonded between the outer and inner shells, wherein a flow path for the medium is formed at the heat transfer plate or outer shell.

2. The double walled pan of claim 1, wherein a circular recess is formed at a center of a heat transfer plate and the plurality of grooves extend from the circular recess to edges of a circumference in all directions.

3. The double walled pan of claim 1, wherein a plurality of grooves extend in parallel with each other from portions of a circumferential edge to the corresponding portions of the circumferential edge, respectively.

4. The double walled pan of claim 1, wherein a plurality of grooves extend from portions of a circumferential edge to the corresponding portions of the circumferential edge so as to cross with each other.

5. The double walled pan of claim 2, wherein eight grooves extend radially from the circular recess on the heat transfer plate.

6. The double walled pan of claim 1, wherein the heat transfer plate is a disc, a concentric recess is formed between a center and an edge of the disc so as to have a predetermined width, and at least two straight grooves extend from the concentric recess to the edge.

7. The double walled pan of claim 6, wherein the concentric recess has the width amounting to about a half of the radius of the disc and eight straight grooves extend from the concentric recess to the edge.

8. The double walled pan of claim 1, wherein a plurality of pillars are formed at the heat transfer plate and density of the pillars at a central or circumferential portion of the heat transfer plate is greater than that of the rest pillars.

9. The double walled pan of one of claims 1 to claims 8, wherein a flat heat transfer plate is attached to the heat transfer plate additionally.

10. The double walled pan of claim 1, wherein the heat transfer plate is flat, the flow path of the heat medium is formed on the outer shell, an outer heat transfer plate is installed at a lower part of the outer shell, and the outer heat transfer plate has at least one groove having the same shape of the outer shell.

11. The double walled pan of claim 10, wherein a stainless steel is added between the heat transfer plate and outer shell.
